(19) United States
(12) Patent Application Publication
(10) Pub. No.: US 2013/0143543 A1
(43) Pub. Date: Jun. 6, 2013

(54) METHOD AND DEVICE FOR AUTOMATICALLY SWITCHING A PROFILE OF A MOBILE PHONE

(71) Applicant: Samsung Electronics Co., Ltd., Gyeonggi-do (KR)

(72) Inventor: Jithendra VEPA, Bangalore (IN)

(73) Assignee: Samsung Electronics Co., Ltd., Gyeonggi-do (KR)

(21) Appl. No.: 13/690,522

(22) Filed: Nov. 30, 2012

(30) Foreign Application Priority Data
Dec. 2, 2011 (IN) 4193/CHE/2011
Nov. 27, 2012 (KR) 10-2012-0135276

(51) Int. Cl. H04W 8/18

(52) U.S. Cl. CPC H04W 8/183
USPC 455/418

(57) ABSTRACT

A device and a method for automatically switching profiles in mobile phones based on the environment of a user are disclosed. The device and the method take into consideration various parameters for changing the profile. The parameters include acoustic parameters, accelerometer parameters, network strength and clock time. Based on all these measured parameters the method builds a graphical model. The graphical model is trained for different profiles. Further, as and when the environment of the user changes, the parameters change. Based on these parameters the graphical model is employed to analyze the probability of different states or profiles. Accordingly, the mobile phone is switched from one profile to another automatically.

### PRIORITY

This application claims priority under 35 U.S.C. §119(a) to an Indian Patent Application Serial No. 4193/CHE/2011, which was filed in the Indian Patent Office on Dec. 2, 2011, and Korean Application Serial No. 10-2012-0135276, which was filed in the Korean Intellectual Property Office on Nov. 27, 2012, the content of each of which is incorporated herein by reference.

### BACKGROUND

1. Field of the Invention

The present invention generally relates to communication devices, and more particularly, to a method and a device for automatically switching profiles in a mobile phone.

2. Description of the Related Art

Advancements in communication technology have enabled users to stay connected anywhere and anytime by employing a mobile phone. There has been a tremendous increase in the use of mobile phones over the years. Although mobile phones enable users to receive calls and messages anytime, there are instances where a user may not like to be disturbed by a phone call or a message. To overcome this problem, most mobile phones are provided with options of different profiles. The profiles enable the user to change his mobile phone settings as per his convenience.

The profiles enable the user to configure features such as ringtone, volume, ringing modes, call screening/filtering, alerts/notifications, visual effects and a variety of other features as desired. The user may desire in certain situations to change the profile of the mobile phone as per the situation. For instance, the mobile phone may offer profiles such as a meeting profile, outdoor profile, home profile, office profile, hands free profile and so on. As the names suggest, the profiles are intended for different purposes. For example, the meeting profile is meant for the purposes of meetings. In such a profile, the vibration may be turned on and the ringtone may be turned off. Further, alerts and notifications for this profile may be deactivated and personal calls may be screened. This may be done for the mere purpose of not disturbing people who are attending the meeting. Considering another example, such as the outdoor profile, both vibration and ringtone may be preferred. Further, the ringing volume may be turned to high volume and alerts and notifications may be activated so that the user is aware of calls and messages when outdoors. Typically, each profile is customizable so that the user can specify which mobile phone functions are affected when profile switching happens.

In the above instances, the user is required to manually press some keys on the mobile phone so as to switch between profiles, which is a burden to the user. Further, there may be scenarios wherein the user forgets to change profiles. For example, the user may be running late for a meeting and in a hurry, and may forget to change the profile to meeting profile. In such a case, as the mobile phone may still be on home profile or outdoor profile the user may continue to receive alerts and notifications. Further, if the user receives a call during this time the ringtone may be loud enough to disturb the meeting in progress, which may cause embarrassment to the user. Due to this, the user must continuously remember to manually change the profile whenever the situation changes. On contrary, if the user forgets to change the profile after a meeting to outdoor mode and is driving back home, there is a possibility that the user may miss important phone calls and alerts or tasks that he requested for a reminder on the way back home. In another example, a second person may want to use a user's mobile phone for some purpose; however, the user may not want the second person to view some contents on the mobile phone, such as, for example, contacts, messages and so on. In such cases, the user needs to carefully remember to change the profile so that the person does not have access to the content. Due to these reasons, it is evident that a lot of manual effort may be required in the process of switching profiles, and hence, many users may prefer not to use them at all. In addition, the existing mechanisms are neither efficient nor convenient.

Some profile changing methods existing today, which take into consideration the intensity of noise for changing the profiles. However, the method of changing the profiles by considering the intensity of noise may be inaccurate as the environment is prone to noise of different types and intensity. For example, operation of a vacuum cleaner at home may lead to misjudgment that the user is outdoors. Hence, the false judgment may lead to profile change. As a result, these methods are not very efficient and difficult to rely on.

Due to at least the aforementioned reasons, there is a requirement for a more efficient and reliable way to enable users to change their profiles automatically based on the environment and situation the user is in. In addition, the mechanism needs to be intelligent enough to determine false situations and take appropriate steps to switch profiles so as to avoid any kind of misjudgment.

### SUMMARY OF THE INVENTION

Accordingly, the present invention is designed to address at least the problems and/or disadvantages described above and to provide at least the advantages described below.

An aspect of the present invention is to provide a method and a device for automatically switching profiles of a mobile phone based on an environment.

Another aspect of the present invention is to provide a method and a device for automatically switching profiles of a mobile phone capable of switching profiles by applying a graphical model according to probability distribution.

Another aspect of the present invention is to provide a method and a device for automatically switching profiles of a mobile phone capable of adapting to new conditions as per the user's requirements by providing intelligence to the graphical model.

According to an aspect of the present invention, a method of automatically switching profiles in a mobile phone based on an environment of a user is provided. The method includes obtaining data related to the environment from a plurality of sources; computing a plurality of parameters from the environment data; building a graphical model employing the parameters; training the graphical model and analyzing various combination values of the parameters computed from a particular environment by using the trained graphic model; and switching the profile of the mobile phone based on the analysis.

According to another aspect of the present invention, a device configured for automatically switching profiles of a mobile phone based on an environment of a user is provided. The device includes a controller configured to collect data related to the environment from a plurality of sources; compute a plurality of parameters from the environment data; build a graphical model employing the parameters; train the graphical model and analyze various combination values of the parameters computed from a particular environment by using the trained graphic model; and switch profiles based on the analysis.

According to a further aspect of the present invention, a method of building and training a graphical model for automatically switching profiles in a mobile phone is provided. The method includes building the graphical model from a plurality of parameters obtained from environment data, determining possible state transitions from the graphical model, and training the graphical model for the transitions.

### BRIEF DESCRIPTION OF THE DRAWINGS

This present invention is illustrated in the accompanying drawings, throughout which like reference numbers indicate corresponding parts in the various figures. The embodiments herein will be better understood from the following description with reference to the drawings, in which:

FIG. 1 is a configuration diagram illustrating a mobile phone for automatic profile switching, according to embodiments of the present invention;

FIG. 2 is a graphical model, according to embodiments of the present invention;

FIG. 3 is a flow diagram illustrating a training process for the graphical model in the mobile phone, according to embodiments of the present invention; and

FIG. 4 is a flow chart illustrating a process of switching profiles automatically in the mobile phone, according to embodiments of the present invention.

### DETAILED DESCRIPTION OF EMBODIMENTS OF THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

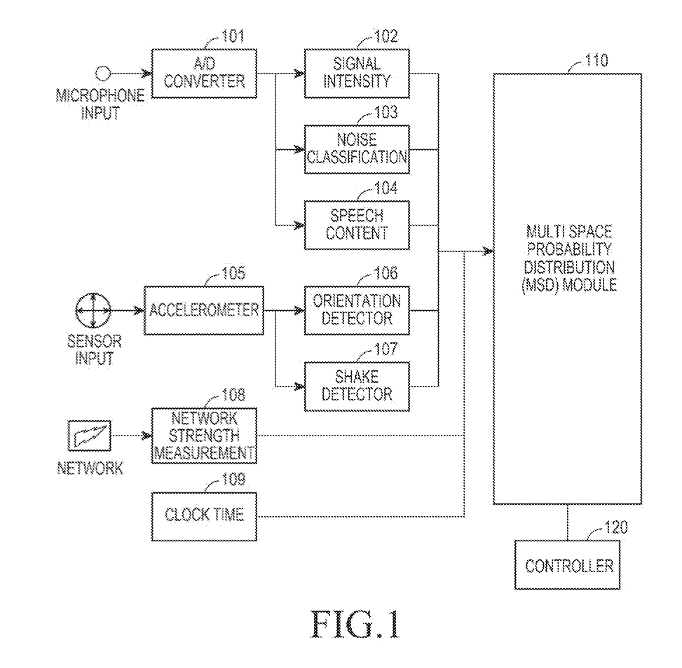

The embodiments of the present invention provide a method for automatically switching profiles in a mobile phone by analyzing the environment of the user. Referring now to the drawings, and more particularly to FIGS. 1 through 4, where similar reference characters denote corresponding features consistently throughout the figures, there are shown the embodiments of the present invention.

A method for automatically switching profiles in mobile phones based on the environment of a user is disclosed. The method takes into consideration various parameters for changing the profile. The parameters include acoustic parameters, accelerometer parameters, network strength and clock time. Based on all these measured parameters the method builds a graphical model. The graphical model is trained for different profiles. Further, as and when the environment of the user changes, the parameters change. Based on these parameters, the graphical model is employed to estimate the probability of different states or profiles. Accordingly, the mobile phone is switched from one profile to another automatically.

FIG. 1 is a configuration diagram illustrating a mobile phone for automatic profile switching, according to embodiments of the present invention. As illustrated in FIG. 1, the system includes various modes of input, such as a microphone, a sensor and the network. The Analog to Digital (A/D) converter 101 takes the signal from the microphone and converts the analog signal to a digital form. This signal is then classified based on some parameters, such as acoustics of the signal. The acoustics measure signal intensity 102 wherein the intensity of the sound from the surroundings is measured. The signal intensity 102 is computed from the short term energy of the signal in dB. To do this, the signal is divided into short frames, and for each frame the signal energy is computed, as given below in Equation (1):

$${Y}_{k} = 10 * log 10 ( {\sum }_{n = 1}^{N} {( x [ n ] )}^{2} ) \\ k = 1 … K ( frame index ) \qquad ( 1 )$$

The intensity indicates the noise level of the acoustic signal. Table 1 below gives an indication of the signal levels.

TABLE 1

| | | |
|---|---|---|
| Signal Intensity | Noise Levels | Source of Sound |

| | | | |
|---|---|---|---|
| <30 | dB | Faint | Calm room, whisper |
| 30-60 | dB | Moderate | Normal talking, rain fall |
| 60-90 | dB | Very loud | Busy traffic, vacuum |
| 90-120 | dB | Extremely loud | Rock music, subway |
| >120 | dB | Painful | Jet engine, grenades |

The noise classification parameter 103 classifies different types of noise. Background noises can be categorized into: (1.) Environmental noise such as traffic noise, wind, animal sounds, etc.; and (2.) Mechanical noise such as machines, air conditioning, power hum, etc. In an embodiment, a Multi-Layer Perceptron (MLP) neural network may be used to classify the noise into one of the two classes (i.e. environmental or mechanical). Input features to the MLP are Mel Frequency Cepstrum Coefficients (MFCC) and cross correlation features.

The speech content parameter 104 measures speech present in the signal acquired from microphone of a mobile phone. This is estimated in terms of percentages for every small segment of the signal. Many voice activity detection (VAD) methods are available in the literature that use features including zero crossing rate, Mel-Frequency Cepstrum Coefficients (MFCC), low-band energies (<1 kHz), and a classifier rule to check whether the values exceed pre-defined thresholds. Once the speech and non-speech detection is done, speech content will be measured as ratio of speech frames to the total frames in the signal, as in Equation (2):

$$Speech Content = \frac{No . of speech frames}{Total frames in the signal} \qquad ( 2 )$$

The accelerometer 105 is responsible for measuring movements. The inputs from the accelerometer 105 are classified into orientation detector 106 that detects the orientation of the mobile phone and shake detector 107 that detects the shake in the mobile phone.

The network strength 108 is responsible for measuring the strength of the network signal. The clock time parameter 109 takes into consideration the time of day such as early morning, morning, mid day, evening, night, late night and so on.

All these parameters are modeled using the Multi-Space probability Distribution (MSD) through a MSD module 110 by using Equation (2) below. The weights of the MSD are estimated using the training data, continuous parameters (e.g. signal intensity, speech content) modeled using Gaussian distribution, and other parameters modeled using a discrete probability table.

A controller 120 controls an overall operation of the mobile phone. The controller 110 collects data on a user environment from at least one of a plurality of sources such as a microphone output, an accelerometer, network signal intensity, and clock time. Further, the controller 120 computes a plurality of parameters from the data on the environment and builds a graphic model by using the parameters. In addition, the controller 120 trains the graphic model and analyzes various combination values of the parameters computed from a particular environment by using the trained graphic model. At this time, the controller 120 inputs the plurality of parameters into the trained graphic module to extract training data in order to analyze the various combination values of the parameters and computes a transition probability value through the training data. Further, the controller 120 determines an observation probability value by using the graphic model modeled using the MSD and determines probability of a current state by multiplying the transition probability value and the observation probability value.

When the analysis of the various combination values of the parameters has been completed, the controller 110 switches profiles based on the analysis.

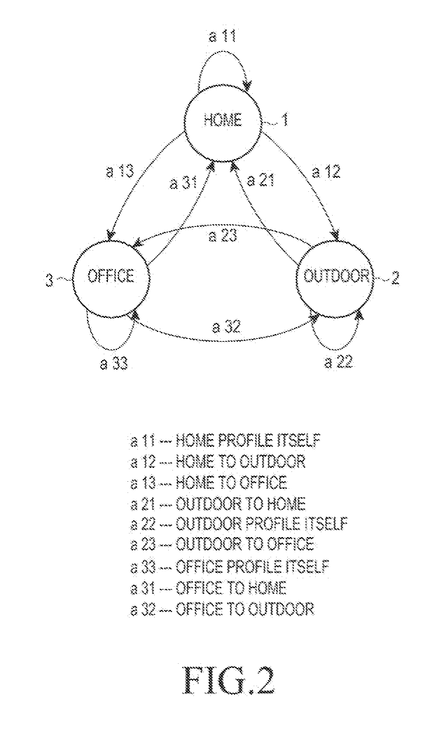

FIG. 2 is a graphical model, according to embodiments of the present invention. The data/signals from various sensors such as an acoustic microphone, accelerometer, network and battery levels are acquired and digitized with respective sampling levels. Then features/cues to be extracted from these signals, which are both continuous and discrete, are obtained. The features/cues include acoustic parameters such as signal intensity, noise classification, speech content, orientation, shake, network strength and clock time. Based on these obtained parameters, a graphical model is built using MSD. The model is then trained for different profiles. Since any state can come after any other state, transition probabilities are computed from the training data.

As depicted in the model, 1, 2 and 3 represent three different possible states (or profiles). The first profile/state is “home 1”, the second profile/state is “outdoor 2”, and the third profile/state is “office 3”. The states are computed using MSD. Since any state can come after any other state, the possibilities are 3×3=9. i.e., 9 different probabilities are possible with three profiles. The states are indicated as a₁₂ for change from “home to outdoor” profile, i.e., 1 to 2; a₂₁ for change from “outdoor to home” profile, i.e., 2 to 1; and a₁₁ is for remaining in same state or home profile itself. In this way, the different transition probabilities for the three profiles are estimated as illustrated in FIG. 2.

Further, the input features have continuous values and discrete labels, and hence MSD is suitable for estimating the probability. In MSD, each parameter has its weight and discrete probability table or continuous probability density function (pdf). Observation vectors need not have all parameters, for example accelerometer data is not available for some time. Each parameter will have an associated weight (w) and probability table or pdf (P). Then the output probability distribution for state, q, can be written as in Equation (2).

$${b}_{q} ( o ) = {\sum }_{x ∈ X} {w}_{xq} {P}_{q} ( x ) \qquad ( 2 )$$

In Equation (2),

$${\sum }_{x = 1}^{X} {w}_{xq} = 1 , i . e . ,$$

weights for a given state, is equal to one. The observation probability for O={o₁, o₂ . . . , o_{T}} is given by Equation (3).

$$P ( O / M ) = {\sum }_{q ∈ Q} {\prod }_{t = 1}^{T} {a}_{{q}_{t - 1} {q}_{t}} {b}_{{q}_{t}} ( {o}_{t} ) \qquad ( 3 )$$

In Equation (3), M is the model, a's are transition probabilities, and b's are output probabilities. The model parameters (A and B) are estimated using well-known a Expectation and Maximization (EM) algorithm on training data. To know the probability of any state, the observation probability (b) is multiplied by the transition probability (a). At any given time, the state that has the highest probability is selected as the desired state. In order to avoid false alarms and make a precise decision on the change of states, model predictions are observed over a small buffer. Once the desired state is known, then a corresponding profile can be chosen and activated. In an embodiment of the present invention, this model can be adapted for the particular user data using techniques like Maximum Likelihood Linear Regression (MLR), and Maximum A Posteriori (MAP), so that it can be personalized for that user.

In an embodiment, this model learns the relationship between various features. For example, the signal intensity, background noise type and accelerometer shake may be related, for states like outdoor or driving and so on. The network signal, speech content and signal intensity might be related in states like home or office. Clock time, background noise, and accelerometer orientation may be related for states like sleep or home. This model can be simple or complex depending on the availability of input features from the sensor and output states, i.e. profiles. The output states of the model can be various profiles of the phone, e.g. Home, Office, Driving, Outdoor, and user created profiles. Each profile can be configured by the user for various settings. Once the model is trained for a particular set of states, it can automatically change the states based on the acquired data from various sensors.

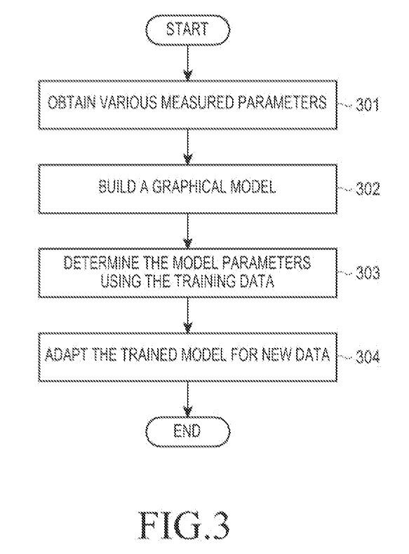

FIG. 3 is a flow diagram illustrating the training process for the graphical model in the mobile phone, according to embodiments of the present invention. In order to determine various profiles of the mobile phone, it is necessary to train the graphical model so that the transition probabilities may be known. For this purpose, different parameters are obtained in step 301 by the mobile phone. The acquired parameters include continuous and discrete values such as acoustic parameters, accelerometer parameters, network signal strength and clock time. All these parameters influence the environment profiles such as driving, outdoor, office and so on. From the measured parameters, a graphical model is built in step 302. In an embodiment of the present invention, MSD is employed for probability estimation for building the graphical model. This is because MSD can handle both discrete and continuous parameters using weights and a discrete probability table or continuous probability density function (pdf). Observation vectors need not have all parameters; for example, accelerometer data is not available for some time. Further, the possible graphical model parameters are determined in step 303 using the training data. Further, the trained model is adapted in step 304 for the new data or the present measured parameters. In this way, once the model is trained for a particular set of states, it can automatically change the states based on the acquired data from various sensors. The various actions in the method of FIG. 3 may be performed in the order presented, in a different order or simultaneously. Further, in some embodiments, some actions listed in FIG. 3 may be omitted.

It is clear to one skilled in the art that the mobile phone referred to herein may be replaced by any communication device capable of supporting different profiles, and the scope of the invention extends to such a communication device as well.

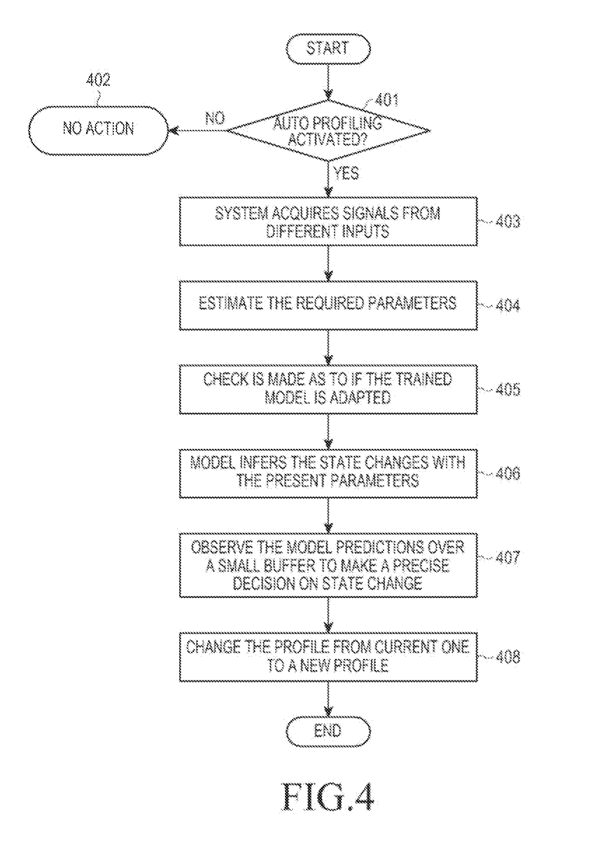

FIG. 4 is a flow chart illustrating the process of switching profiles automatically in the mobile phone, according to embodiments of the present invention. A determination is made in step 401 if the automatic profile changing feature is active on the mobile phone of the user. If the auto profiling is deactivated then no action is taken in step 402. If auto profiling is active, the system acquires signals from different inputs in step 403. The inputs are accelerometer, microphone, and network signal and clock time. Through the input signals, the required parameters such as signal intensity, noise classification, speech content, orientation, shake, clock time and so on are determined in step 404. All these parameters are inter-related as they help in determining the state or profile of the user. The obtained parameters are input in step 405 to the trained graphical model and a determination is made for the adaptation of the model to present parameters. The model takes into consideration present obtained parameters for computing the probabilities for output states in step 406. In an embodiment of the present invention, to determine the probability of any state, the observation probability is multiplied by the transition probability. At any given time, the state that has the highest probability as the desired state is selected. For example, if the user starts in the home profile, as soon as he is outdoors, the parameters change and the probability for the home profile also changes, corresponding for other profiles. Then these probabilities are multiplied with transition probabilities and the state transition (including self transition, i.e. it can stay in same profile) with highest cumulative probability will be chosen. Further, the model predictions are observed in step 407 over a small buffer to make a precise decision on a state change and to avoid any false alarms. If a majority of model predictions during this time buffer indicates a particular state then the profile is changed to that state. In an example, when the mobile phone is in a home environment there may be a possibility of false alarm and misjudgment due to use of an appliance such as a vacuum cleaner in the house leading to change in the profile. As a result, to avoid false alarms due to some short time noise bursts and signal acquisition errors, the small buffer is used to change the profile if the same state is predicted for example, 3 to 5 consecutive times, and the system will change the profile corresponding to that state. Finally, the profile of the mobile phone is changed in step 408 to the new profile. The various actions in FIG. 4 may be performed in the order presented, in a different order or simultaneously. Further, in some embodiments, some actions listed in FIG. 4 may be omitted.

The method of the present invention has several advantages, such as all input parameters need not be available at a particular time to estimate the probability of belonging to particular state. Further, the model takes both continuous values (e.g. signal intensity) and discrete or categorical values (e.g. calendar time, morning, evening and so on) into account for state transition. The model will be able to learn the relations between various features, such as signal intensity, background noise type and accelerometer shake, may be related, for states like outdoor or driving. Network signal, speech content and signal intensity might have relation in states like home or office. Clock time, background noise, accelerometer orientation may be related for states like sleep or home.

Further, the model is able to adapt to new data, i.e. the parameters will be modified according to user data, so that it can be personalized for a particular user.

The embodiments disclosed herein can be implemented through at least one software program running on at least one hardware device and performing network management functions to control the elements. The elements shown in FIG. 1 include blocks that can be at least one of a hardware device, or a combination of a hardware device and software module.

The foregoing description of the specific embodiments so fully reveals the nature of the present invention that others skilled in the art can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described, those skilled in the art will recognize that the embodiments herein can be practiced with modification within the spirit and scope of the invention as described herein.

What is claimed:

1. A method of automatically switching profiles in a mobile phone based on an environment of a user, the method comprising:
obtaining data related to the environment from a plurality of sources;
computing a plurality of parameters from the environment data;
building a graphical model employing the parameters;
training the graphical model;
analyzing various combination values of the parameters computed from a particular environment by using the trained graphic model; and
switching the profile of the mobile phone based on the analyzed combination values.

2. The method as in claim 1, wherein the plurality of sources include at least one among microphone input, accelerometer, network signal strength, and clock time.

3. The method as in claim 1, wherein the plurality of parameters include at least one of signal intensity, noise classification, speech content, shake detection, orientation detection, network signal strength, and clock time.

4. The method as in claim 1, wherein the plurality of parameters have continuous and discrete values.

5. The method as in claim 1, wherein the graphic model is modeled using Multi Space probability Distribution (MSD).

6. The method as in claim 1, wherein the graphical model adapts to the particular environment by using at least one of Maximum Likelihood Linear Regression (MLR), and Maximum A Posteriori (MAP) for adapting the graphical model.

7. The method as in claim 1, wherein analyzing the various combination values comprises:
inputting the plurality of parameters into the trained graphic model to extract training data;
computing transition probability value through the training data;
determining an observation probability value by using the graphic model modeled using Multi Space probability Distribution (MSD); and
determining probability of a current state by multiplying the transition probability value and the observation probability value.

8. The method as in claim 1, wherein switching the profile comprises, when an equal state based on the analysis is maintained for a predetermined time, switching the profile to a profile corresponding to the state.

9. A device configured to automatically switch profiles of a mobile phone based on an environment of a user, the device comprising:
a receiver for receiving data related to the environment from a plurality of sources; and
a controller configured to compute a plurality of parameters from the environment data, build a graphical model employing the parameters, train the graphical model, analyze various combination values of the parameters computed from a particular environment by using the trained graphic model, and switch the profiles based on the analyzed combination values.

10. The device as in claim 9, wherein the plurality of sources include at least one among microphone input, accelerometer, network signal strength, and clock time.

11. The device as in claim 9, wherein the plurality of parameters include at least one of signal intensity, noise classification, speech content, shake detection, orientation detection, network signal strength, and clock time.

12. The device as in claim 9, wherein the plurality of parameters have continuous and discrete values.

13. The device as in claim 9, wherein the graphic model is modeled using Multi Space probability Distribution (MSD).

14. The device as in claim 9, wherein the graphical model adapts to the particular environment by using at least one of Maximum Likelihood Linear Regression (MLR), and Maximum A Posteriori (MAP) for adapting the model.

15. The device as in claim 9, wherein the controller inputs the plurality of parameters into the trained graphic model to extract training data in order to analyze various combination values of the parameters; computes a transition probability value through the training data; determines an observation probability value by using the graphic model modeled using Multi Space probability Distribution (MSD); and determines probability of a current state by multiplying the transition probability value and the observation probability value.

16. The device as in claim 9, wherein, when an equal state based on the analysis is maintained for a predetermined time, the controller switches the profile to a profile corresponding to the state.

17. A method of building and training a graphical model for automatically switching profiles in a mobile phone, the method comprising:
building the graphical model from a plurality of parameters obtained from environment data;
determining possible state transitions from the graphical model; and
training the graphical model for the transitions.

18. The method as in claim 17, wherein determining possible state transitions is done by employing a Multi Space probability Distribution (MSD) model.

19. The method as in claim 17, wherein the plurality of parameters include at least one of signal intensity, noise classification, speech content, shake detection, orientation detection, network signal strength, and clock time.

20. The method as in claim 17, wherein building the graphical model comprises adapting the graphic model to a particular environment by using at least one of Maximum Likelihood Linear Regression (MLR), and Maximum A Posteriori (MAP).
